(19) United States
(12) Patent Application Publication
(10) Pub. No.: US 2014/0203766 A1
(43) Pub. Date: Jul. 24, 2014

(54) SMT SYSTEM

(71) Applicant: Michael Charles Bertsch, San Francisco, CA (US)

(72) Inventor: Michael Charles Bertsch, San Francisco, CA (US)

(21) Appl. No.: 14/189,936

(22) Filed: Feb. 25, 2014

Related U.S. Application Data
(63) Continuation-in-part of application No. 13/269,105, filed on Oct. 7, 2011.
(60) Provisional application No. 61/404,655, filed on Oct. 7, 2010.

(51) Int. Cl. H02K 21/02; H02J 7/14

(52) U.S. Cl. CPC H02K 21/02; H02J 7/14
USPC 320/107; 310/152; 320/135; 310/77

(57) ABSTRACT

The present invention provides a permanent magnet electric apparatus which is designed to couple to a generator and/or turbine output shaft to create electricity. More particularly, the invention seeks to provide a permanent magnet electric apparatus which includes a rigid spherically shaped supporting outer structure and/or irregular shaped structure and/or enclosure that houses a permanent magnet electric apparatus which further includes a rotor structure, a stator structure, a magnet assembly, a plurality of such equally spaced recessed magnets, one or more support column, one or more support beam, a support base, a plurality of gears, an alternator device, a rechargeable battery, a control panel, an ON/OFF switch and/or button, a voltage and/or current regulator, a hydraulic breaking system including assembly and one or more flooring systems including supporting walls. Methods of using the magnetic electric turbine are also provided.

### CROSS-REFERENCE TO RELATED APPLICATIONS

This is a continuation in part application that claims priority to U.S. Provisional Patent Application Ser. No. 13/269,105 filed on Oct. 7, 2011, which is a continuation of U.S. Application Ser. No. 61/404,655 filed on Oct. 7, 2010, which is hereby incorporated by reference in its entirety for all purposes.

### BACKGROUND OF THE INVENTION

Electrical generators and/or turbine are devices that convert mechanical energy into electrical energy and are well known. The underlying operating principal of these generators can be found in Faraday's law which, in its most basic form, states that an electrical potential difference is generated between the ends of an electrical conductor that moves perpendicularly through a magnetic field. More specifically, that the electromotive force (EMF) that is induced in any closed circuit is equal to the time rate of change of the magnetic flux through the circuit. An electrical generator in its most simple form comprises a rotor and a stator. The rotor is a rotating part of the generator and the stator is a stationary part. One particular class of electrical generator makes use of permanent magnets (PMs), mounted on either the rotor or the stator, to establish a magnetic field (flux) in the generator. These generators are referred to as permanent magnet generators. Coils of conductive material (normally copper wire) are secured to either the stator or the rotor of the generator and as the rotor rotates with respect to the stator, the movement of the magnetic field relative to the conductive windings induces a current in the windings. The current so induced may then be used to power electrical appliances or to store electrical charge by, for example, charging batteries. Electrical generators are currently used in a number of applications, but are becoming increasingly popular for use in wind generators, mainly because electricity generated by means of wind is considered to be a clean source of energy. Wind generators convert the kinetic energy of wind into mechanical (mostly rotational) energy which is then converted into useful electrical energy. A basic wind generator includes a number of aero foil shaped blades, mounted on an axle for rotation in wind. The rotation is imparted to the rotor of an electrical generator which, in turn, generates electricity. Conventional wind generators suffer from a number of disadvantages. One such disadvantage is that the majority of such generators utilize iron core stators. Apart from the high cost associated with iron cores, they are also heavy and require additional resources and support to install, stabilize and maintain. Iron core stators also suffer from cogging torque, which is the torque resulting from the interaction between the permanent magnets of the rotor and the stator slots of a PM machine. It is also known as detent or “no-current” torque. Cogging torque is an undesirable component for the operation of iron-core electric generators. It is especially prominent at lower speeds and manifests itself in stuttered rotation. A further disadvantage of conventional wind generators is the cost associated with their repair and maintenance. In particular, where windings on either the rotor or stator become worn or defective, highly skilled technicians are required to conduct repair or maintenance. The weight and unwieldiness of conventional iron-core stators also often require the use of machinery or teams of technicians to conduct even routine maintenance. One improved type of wind generator that has been used with some success, particularly in wind generators, is known as a double-sided rotor, air-cored permanent magnet generator. Due to its air core stator, the generator does not suffer from some of the disadvantages mentioned above resulting from a heavy iron core generator. These generators have numerous advantages such as no core losses, zero cogging torque, no attractive forces between the stator and rotor and the ability of replacing faulty stators in situ. The stators are, however, still difficult to repair and maintain, and still require highly skilled technicians and expensive equipment to do so. In addition, these machines suffer from large attractive forces between the two PM rotors and normally require a relatively large number of PM magnets to operate due to the fact that they have a relatively larger air gap between the rotors and stator. There is a need to improve the method and means for creating electrical power with greater ease. The present invention overcomes the deficiencies of such design for a permanent magnet electric apparatus.

### BRIEF SUMMARY OF THE INVENTION

The present invention comprises a permanent magnet electric apparatus which is designed to couple to a generator and/or turbine output shaft to create electricity. The energy generated by this present invention can be used in many other applications. The present invention also provides an effective and reliable process for the generation (i.e., production) of energy. An object of this invention is such the generation of energy. Another such object of this present invention is the generation of such energy which can be used directly. Another such object of this present invention is the generation of energy which can be used indirectly. Another such object of this present invention is to provide an apparatus for generating energy. Another such object of this present invention is to provide an apparatus for use as an engine and/or motor. Another such object of this invention is to provide an apparatus for such use as a rotary engine. Another such object of this present invention is to provide an apparatus which generates a long term supply of energy. Another object of this present invention is to provide an apparatus which is compatible with various forms of engines and/or motors, such as a battery and/or solar powered engines and/or motors. Another object of this present invention is to provide such an apparatus in which magnetic fields can be harnessed in such an efficient manner. Another object of this present invention is to provide such an apparatus in which magnetic fields can be harnessed in such an efficient manner to produce such lateral force. Another object of this present invention is to provide an apparatus which converts stored energy into kinetic energy. A further characteristic of the present invention is to provide another object for such process for generating energy. A further characteristic of the present invention is to provide another object for such a process which can be used in an engine or motor. A further characteristic of the present invention is to provide another object for such a process which can be used in a rotary engine. A further characteristic of the present invention is to provide another object for such a process which generates a long term supply of energy. A further characteristic of the present invention is to provide another object for such a process which can be used in various forms of engines and/or motors, such as a battery and/or solar powered engines and/or motors. A further characteristic of the present invention is to provide another object for such a process in which magnetic fields can be harnessed in an efficient manner. A further characteristic of the present invention is to provide another object for such a process in which magnetic fields can be harnessed in such an efficient manner to produce lateral force. A further characteristic of the present invention is to provide another object for such a process for converting stored energy into such kinetic energy. The various features of novelty which characterize the invention are pointed out with particularity in the claims annexed to and forming a part of this disclosure. The invention can be more fully understood by reading the subsequent detailed description and examples with references made to the accompanying drawings, wherein:

FIG. 1 depicts a front-cutaway view drawing illustrating an exemplary of the SMT System according to the present invention;

FIG. 2 depicts a side-cutaway view drawing illustrating an exemplary of the SMT System according to the present invention;

FIG. 3 depicts a top-cutaway view drawing illustrating an exemplary of the SMT System according to the present invention;

### BRIEF DESCRIPTION OF THE SEVERAL VIEWS OF THE DRAWING(S)

Embodiments of the invention may be best understood by referring to the following description and accompanying drawings, which illustrate such embodiments. In the drawings:

FIG. 1 depicts a front-cutaway view drawing illustrating an exemplary of the SMT System according to the present invention;

FIG. 2 depicts a side-cutaway view drawing illustrating an exemplary of the SMT System according to the present invention;

FIG. 3 depicts a top-cutaway view drawing illustrating an exemplary of the SMT System according to the present invention;

The drawings are not necessarily to scale. Like numbers used in the figures refer to like components, steps, and the like. However, it will be understood that the use of a number to refer to a component in a given figure is not intended to limit the component in another figure labeled with the same number.

### DETAILED DESCRIPTION OF THE INVENTION

The present invention provides a permanent magnet electric apparatus which is designed to couple to such a generator and/or turbine output shaft to create electricity. More particularly, the invention seeks to provide a permanent magnet electric apparatus including a rotor structure and a stator structure. A magnet assembly fastened by means to such outer rim of such rotor includes a plurality of such equally spaced recessed magnets that act against each other and in such keep attracting and/or repelling when passing in such rotation a recessed stator structure at base of such structure. The recessed stator structure has a plurality of such angled and/or wedged magnets housed in such a cone shaped structure and are in such oriented apposing to such (NS) thus creating repelling forces needed for such rotation. The permanent magnet electric apparatus includes a rigid spherically shaped supporting outer structure and/or irregular shaped structure and/or enclosure that houses in such a permanent magnet electric apparatus which includes a plurality of gears, a rechargeable battery including assembly, hydraulic breaking system including assembly and an electric starting mechanism including assembly. The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents. Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein. The referenced items are provided solely for their disclosure prior to the filing date of the present application. Nothing herein is to be construed as an admission that the present invention is not entitled to antedate such material by virtue of prior invention. Unless otherwise indicated, the words and phrases presented in this document have their ordinary meanings to one of skill in the art. Such ordinary meanings can be obtained by reference to their use in the art and by reference to general and scientific dictionaries, for example, Webster's Third New International Dictionary, Merriam-Webster Inc., Springfield, Mass., 1993 and The American Heritage Dictionary of the English Language, Houghton Mifflin, Boston Mass., 1981. References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. The following explanations of certain terms are meant to be illustrative rather than exhaustive. These terms have their ordinary meanings given by usage in the art and in addition include the following explanations. As used herein, the term “and/or” refers to any one of the items, any combination of the items, or all of the items with which this term is associated. As used herein, the singular forms “a,” “an,” and “the” include plural reference unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation. As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. As used herein, the terms “include,” “for example,” “such as,” and the like are used illustratively and are not intended to limit the present invention. As used herein, the terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention. As used herein, the terms “front,” “back,” “rear,” “upper,” “lower,” “right,” and “left” in this description are merely used to identify the various elements as they are oriented in the FIGS, with “front,” “back,” and “rear” being relative apparatus. These terms are not meant to limit the element which they describe, as the various elements may be oriented differently in various applications. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

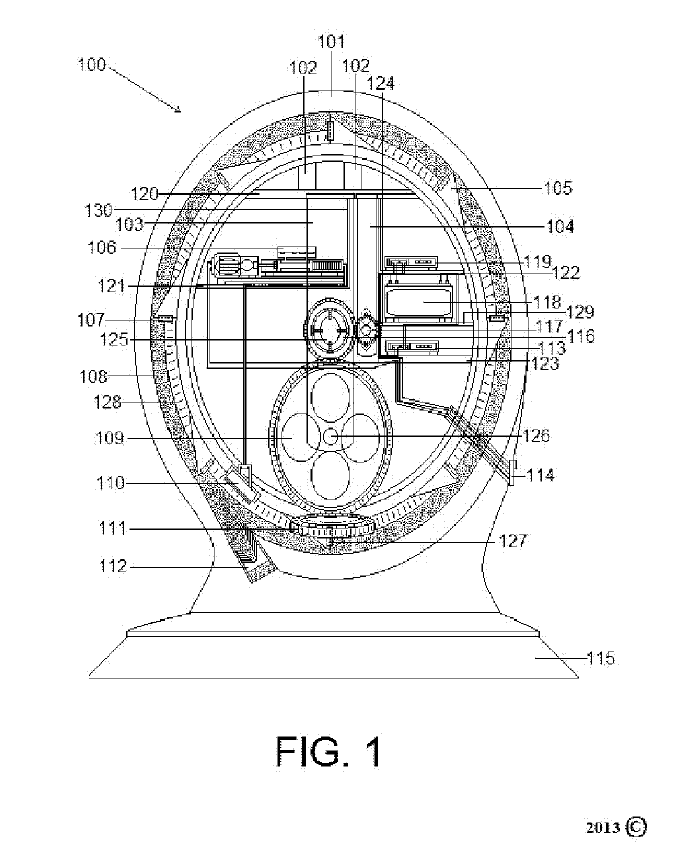

FIG. 1 depicts a front cutaway view drawing illustrating an exemplary of the SMT System according to the present invention; 100 The permanent magnet electric apparatus 100 includes a rigid spherically shaped supporting outer structure and/or irregular shaped structure and/or enclosure 101 that houses in such a permanent magnet electric apparatus 100. In this embodiment one or more parallel spaced apart support columns 102 which include a support assembly (not shown) are fastened by means to such upper floor support beam 120 and such upper interior wall (not shown) of such rigid spherically shaped supporting structure and/or irregular shaped structure and/or enclosure 101. A middle support column 103 is fastened by means to such upper floor support beam 120 and in such supports the first rotatable gear 109 including assembly 126 (partially shown). A second rotatable gear 111 including assembly 127 (partially shown) is included and is in constant mesh with such first gear 109 and such third gear and/or rotatable rotor structure 128 which includes such assembly (not shown). The third rotatable gear and/or rotatable rotor structure 128 including assembly (not shown) is in constant rotation from such repelling forces from such magnet assembly 107. The magnet assembly is in such fastened by means to such outer rim 105 of such third gear and/or rotatable rotor structure 128 and includes a plurality of such equally spaced recessed magnets that act against each other and in such keep attracting and/or repelling when passing in such rotation a recessed stator structure 112 at base of such structure. The recessed stator structure 112 has a plurality of such angled and/or wedged magnets housed in such a cone shaped structure and are in such oriented apposing to such (NS) thus creating repelling forces needed for such rotation which includes a chamber for housing 108 such third gear and/or rotatable rotor structure 128. The permanent magnet electric apparatus 100 includes a hydraulic brake gear motor with a brake mechanism assembly 110 (partially shown) with one or more such chambers for such storage of hydraulic fluid 106. In the embodiment shown, a control panel 114 fastened by means to such exterior of such rigid spherically shaped supporting structure and/or irregular shaped structure and/or enclosure 101 of such permanent magnet electric apparatus 100. The control panel 114 includes an ON/OFF switch and/or button for switching the power supply and/or the releasing and/or stopping of such hydraulic brake gear motor with a brake mechanism assembly 110 (partially shown). The present invention includes a support base 115 for supporting a rigid spherically shaped supporting outer structure and/or irregular shaped structure and/or enclosure 101 that houses in such a permanent magnet electric apparatus 100. A fourth rotatable gear 116 is fastened by means to such output shaft 125 of such generator and/or turbine and is in such constant mesh with such first rotatable gear 109 and such fifth rotatable gear and/or alternator device 117. A support column 104 is fastened by means to such upper floor support beam 120 and in such supports such fifth rotatable gear and/or alternator device 117 including assembly (not shown). The fifth rotatable gear and/or alternator device 117 provided is in such connected to a voltage regulator device 113. The voltage regulator device 113 provided controls such fifth rotatable gear and/or alternator device 117 one or more outputs. A battery charging system is provided, comprising a rechargeable battery type device 118 which includes at least one rechargeable battery cell with such assembly (not shown) including one or more charging circuits connected to such charger connector; and a controller connected to such charger connector for the charging of such rechargeable battery type device 118 which includes a plurality of outputs. A voltage and/or current regulator 119 for regulating such electrical current flow entering and/or leaving such rechargeable battery type device 118 is included. The present invention includes one or more flooring systems 121,122,123,129 including supporting walls 124,130 that are fastened by means to a support (not shown) and are in such especially designed for the housing of such equipment, such as rechargeable battery type device 118, voltage regulator device 113, hydraulic brake gear motor with a brake mechanism assembly 110, voltage and/or current regulator 119.

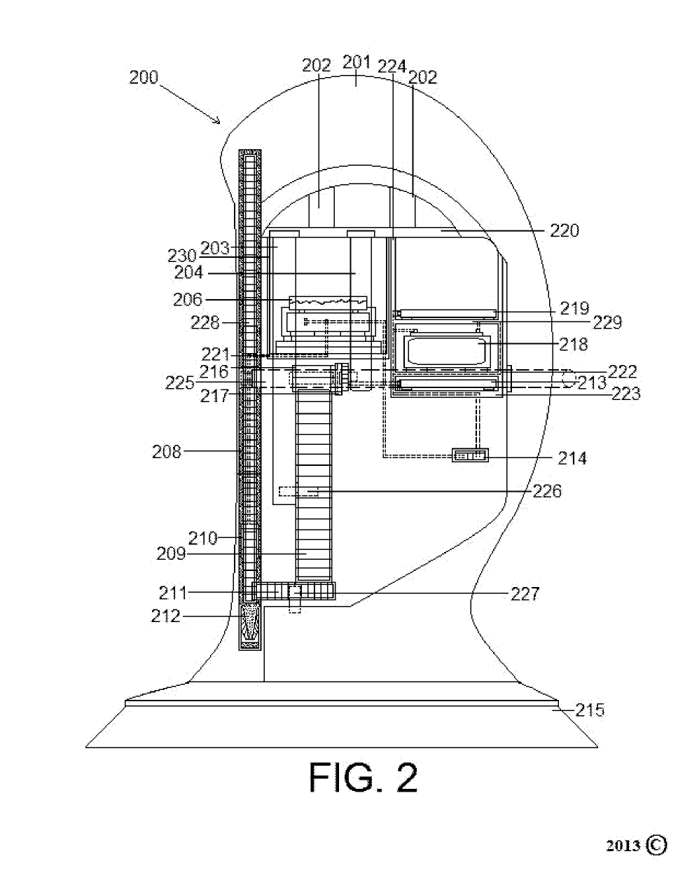

FIG. 2 depicts a side-cutaway view drawing illustrating an exemplary of the SMT System according to the present invention; 200 The permanent magnet electric apparatus 200 includes a rigid spherically shaped supporting outer structure and/or irregular shaped structure and/or enclosure 201 that houses in such a permanent magnet electric apparatus 200. In this embodiment one or more parallel spaced apart support columns 202 which include a support assembly (not shown) are fastened by means to such upper floor support beam 220 and such upper interior wall (not shown) of such rigid spherically shaped supporting structure and/or irregular shaped structure and/or enclosure 201. A middle support column 203 is fastened by means to such upper floor support beam 220 and in such supports the first rotatable gear 209 including assembly 226 (partially shown). A second rotatable gear 211 including assembly 227 (partially shown) is included and is in constant mesh with such first gear 209 and such third gear and/or rotatable rotor structure 228 which includes such assembly (not shown). The third rotatable gear and/or rotatable rotor structure 228 including assembly (not shown) is in constant rotation from such repelling forces from such magnet assembly (not shown). The magnet assembly is in such fastened by means to such outer rim (not shown) of such third gear and/or rotatable rotor structure 228 and includes a plurality of such equally spaced recessed magnets that act against each other and in such keep attracting and/or repelling when passing in such rotation a recessed stator structure 212 at base of such structure. The recessed stator structure 212 has a plurality of such angled and/or wedged magnets housed in such a cone shaped structure and are in such oriented apposing to such (NS) thus creating repelling forces needed for such rotation which includes a chamber for housing 208 such third gear and/or rotatable rotor structure 228. The permanent magnet electric apparatus 200 includes a hydraulic brake gear motor with a brake mechanism assembly 210 (partially shown) with one or more such chambers for such storage of hydraulic fluid 206. In the embodiment shown, a control panel 214 fastened by means to such exterior of such rigid spherically shaped supporting structure and/or irregular shaped structure and/or enclosure 201 of such permanent magnet electric apparatus 200. The control panel 214 includes an ON/OFF switch and/or button for switching the power supply and/or the releasing and/or stopping of such hydraulic brake gear motor with a brake mechanism assembly 210 (partially shown). The present invention includes a support base 215 for supporting a rigid spherically shaped supporting outer structure and/or irregular shaped structure and/or enclosure 201 that houses in such a permanent magnet electric apparatus 200. A fourth rotatable gear 216 is fastened by means to such output shaft 225 of such generator and/or turbine and is in such constant mesh with such first rotatable gear 209 and such fifth rotatable gear and/or alternator device 217. A support column 204 is fastened by means to such upper floor support beam 220 and in such supports such fifth rotatable gear and/or alternator device 217 including assembly (not shown). The fifth rotatable gear and/or alternator device 217 provided is in such connected to a voltage regulator device 213. The voltage regulator device 213 provided controls such fifth rotatable gear and/or alternator device 217 one or more outputs. A battery charging system is provided, comprising a rechargeable battery type device 218 which includes at least one rechargeable battery cell with such assembly (not shown) including one or more charging circuits connected to such charger connector; and a controller connected to such charger connector for the charging of such rechargeable battery type device 218 which includes a plurality of outputs. A voltage and/or current regulator 219 for regulating such electrical current flow entering and/or leaving such rechargeable battery type device 218 is included. The present invention includes one or more flooring systems 221,222,223,229 including supporting walls 224,230 that are fastened by means to a support (not shown) and are in such especially designed for the housing of such equipment, such as rechargeable battery type device 218, voltage regulator device 213, hydraulic brake gear motor with a brake mechanism assembly 210, voltage and/or current regulator 219.

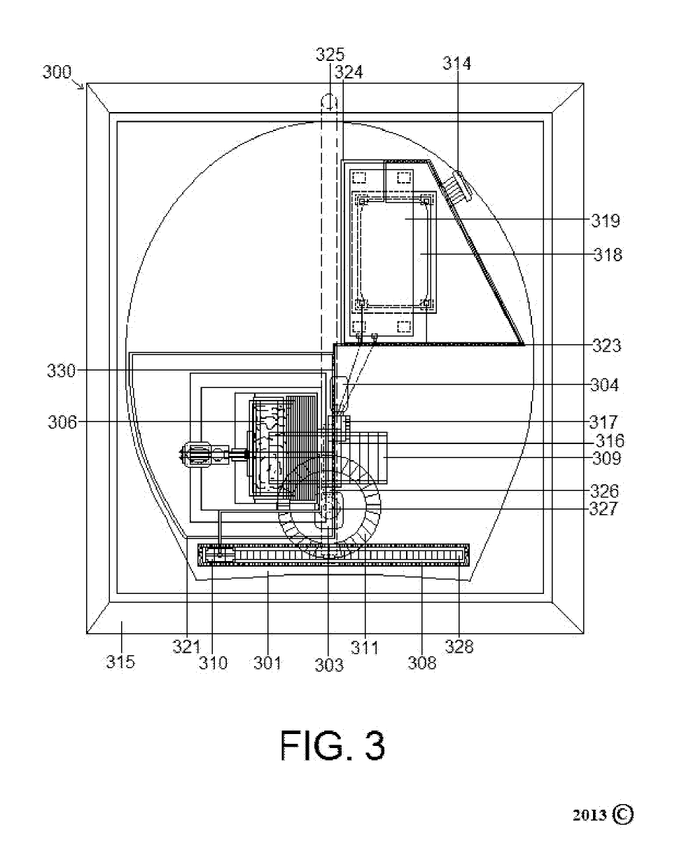

FIG. 3 depicts a top-cutaway view drawing illustrating an exemplary of the SMT System according to the present invention; 300. The permanent magnet electric apparatus 300 includes a rigid spherically shaped supporting outer structure and/or irregular shaped structure and/or enclosure 301 that houses in such a permanent magnet electric apparatus 300. In this embodiment a middle support column 303 is fastened by means to such upper floor support beam (not shown) and in such supports the first rotatable gear 309 including assembly 326 (partially shown). A second rotatable gear 311 including assembly 327 (partially shown) is included and is in constant mesh with such first gear 309 and such third gear and/or rotatable rotor structure 328 which includes such assembly (not shown). The present invention includes a chamber for housing 308 such third gear and/or rotatable rotor structure 328. The third rotatable gear and/or rotatable rotor structure 328 including assembly (not shown) is in constant rotation from such repelling forces from such magnet assembly (not shown). The permanent magnet electric apparatus 300 includes a hydraulic brake gear motor with a brake mechanism assembly 310 (partially shown) with one or more such chambers for such storage of hydraulic fluid 306. In the embodiment shown, a control panel 314 fastened by means to such exterior of such rigid spherically shaped supporting structure and/or irregular shaped structure and/or enclosure 301 of such permanent magnet electric apparatus 300. The control panel 314 includes an ON/OFF switch and/or button for switching the power supply and/or the releasing and/or stopping of such hydraulic brake gear motor with a brake mechanism assembly 310 (partially shown). The present invention includes a support base 315 for supporting a rigid spherically shaped supporting outer structure and/or irregular shaped structure and/or enclosure 301 that houses in such a permanent magnet electric apparatus 300. A fourth rotatable gear 316 is fastened by means to such output shaft 325 of such generator and/or turbine and is in such constant mesh with such first rotatable gear 309 and such fifth rotatable gear and/or alternator device 317. A support column 304 is fastened by means to such upper floor support beam (not shown) and in such supports such fifth rotatable gear and/or alternator device 317 including assembly (not shown). The fifth rotatable gear and/or alternator device 317 provided is in such connected to a voltage regulator device (not shown). A battery charging system is provided, comprising a rechargeable battery type device 318 which includes at least one rechargeable battery cell with such assembly (not shown) including one or more charging circuits connected to such charger connector; and a controller connected to such charger connector for the charging of such rechargeable battery type device 318 which includes a plurality of outputs. A voltage and/or current regulator 319 for regulating such electrical current flow entering and/or leaving such rechargeable battery type device 318 is included. The present invention includes one or more flooring systems 321, 323 including supporting walls 324,330 that are fastened by means to a support (not shown) and are in such especially designed for the housing of such equipment, such as rechargeable battery type device 318, voltage regulator device (not shown), hydraulic brake gear motor with a brake mechanism assembly 310, voltage and/or current regulator 319.

Similarly, except as explicitly required by claim language, a single substance or component may meet more than a single functional requirement, provided that the single substance fulfills the more than one functional requirement as specified by claim language. All patents, patent applications, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Additionally, all claims in this application, and all priority applications, including but not limited to original claims, are hereby incorporated in their entirety into, and form a part of, the written description of the invention. Applicant reserves the right to physically incorporate into this specification any and all materials and information from any such patents, applications, publications, scientific articles, web sites, electronically available information, and other referenced materials or documents. Applicant reserves the right to physically incorporate into any part of this document, including any part of the written description, the claims referred to above including but not limited to any original claims.

All patents, patent applications, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Additionally, all claims in this application, and all priority applications, including but not limited to original claims, are hereby incorporated in their entirety into, and form a part of, the written description of the invention. Applicant reserves the right to physically incorporate into this specification any and all materials and information from any such patents, applications, publications, scientific articles, web sites, electronically available information, and other referenced materials or documents. Applicant reserves the right to physically incorporate into any part of this document, including any part of the written description, the claims referred to above including but not limited to any original claims.

### DESCRIPTION OF RELATED ART

Not Applicable

### INCORPORATION-BY-REFERENCE OF MATERIAL SUBMITTED ON A COMPACT DISC

Not Applicable

### THE NAMES OF THE PARTIES TO A JOINT RESEARCH AGREEMENT

Not Applicable

### STATEMENT REGARDING FEDERALLY SPONSORED RESEARCH OR DEVELOPMENT

Not Applicable

### SEQUENCE LISTING

Not Applicable

### FIELD OF THE INVENTION

The present invention relates primarily to an electrical generator. More particularly, the invention relates to such design for a permanent magnet electric apparatus which is designed to couple to a generator and/or turbine output shaft to create electricity. The invention extends to such method for manufacturing a permanent magnet electrical apparatus.

1. A permanent magnet electric apparatus for creating electrical energy. The permanent magnet electric apparatus comprises of a rotor structure and a stator structure which includes one or more magnet assemblies.
The magnet assemblies are in such fastened by means to such outer rim of such rotor structure which include a plurality of such equally spaced recessed magnets that act against each other and in such keep attracting and/or repelling when passing in such rotation a recessed stator structure at base of such structure.
The recessed stator structure includes a plurality of such angled and/or wedged magnets housed in such a cone shaped structure and are in such oriented apposing to such (NS) thus creating repelling forces needed for such rotation. The permanent magnet electric apparatus includes a rigid spherically shaped supporting outer structure and/or irregular shaped structure and/or enclosure that houses in such a permanent magnet electric apparatus.

2. The permanent magnet electric apparatus of claim 1, further comprising a control panel which includes an ON/OFF switch and/or button for switching the power supply and/or the releasing and/or stopping of such hydraulic brake gear motor with a brake mechanism including assembly.

3. The permanent magnet electric apparatus of claim 1, further comprising a rigid spherically shaped supporting outer structure and/or irregular shaped structure and/or enclosure that houses in such a permanent magnet electric apparatus.

4. The permanent magnet electric apparatus of claim 1, further comprising one or more rechargeable battery type device which includes at least one rechargeable battery cell with such assembly including one or more charging circuits connected to such charger connector; and a controller connected to such charger connector for the charging of such rechargeable battery type device which includes a plurality of outputs.

5. The permanent magnet electric apparatus of claim 1, further comprising one or more voltage and/or current regulators for regulating such electrical current flow entering and/or leaving such rechargeable battery type device.

6. The permanent magnet electric apparatus of claim 1, further comprising a support base for supporting a rigid spherically shaped supporting outer structure and/or irregular shaped structure and/or enclosure that houses in such a permanent magnet electric apparatus.

7. The permanent magnet electric apparatus of claim 1, further comprising a rotatable gear and/or alternator device including assembly which is connected by means to such voltage regulator device which controls such rotatable gear and/or alternator device one or more outputs.

8. The permanent magnet electric apparatus of claim 1, further comprising a hydraulic brake gear motor with a brake mechanism assembly including one or more chambers for storage of hydraulic fluid.
